(19) United States
(12) Patent Application Publication
(10) Pub. No.: US 2025/0208447 A1
(43) Pub. Date: Jun. 26, 2025

(54) OPTICAL MODULATION DEVICE

(71) Applicants: HUAWEI TECHNOLOGIES CANADA CO., LTD., Kanata (CA); THE UNIVERSITY OF OTTAWA, Ottawa (CA)

(72) Inventors: Nikhil DHINGRA, Delhi (IN); Pierre Simon Joseph BERINI, Orleans (CA); Hamid MEHRVAR, Ottawa (CA)

(21) Appl. No.: 19/078,748

(22) Filed: Mar. 13, 2025

Related U.S. Application Data
(63) Continuation of application No. PCT/IB2023/050331, filed on Jan. 13, 2023.

(51) Int. Cl. G02F 1/025

(52) U.S. Cl. CPC G02F 1/025

(57) ABSTRACT

An optical modulation device including a substrate defining a recess on a top surface thereof, an optical waveguide configured for guiding an optical signal therein, the optical waveguide being disposed in the recess, a first stack assembly disposed on the top surface of the substrate and at least partially above the optical waveguide and a second stack assembly disposed on the top surface of the substrate and at least partially above the optical waveguide is disclosed. The first and second stack assemblies extend parallel to each other on an active portion of the optical waveguide, the first and second stack assemblies being separated by a gap, each of the first and second stack assemblies including a cathode layer, an inorganic semi-conductive material film disposed atop the cathode layer, an insulating coating disposed atop the inorganic semi-conductive material film and an anode layer disposed on the insulating coating.

### CROSS-REFERENCE

The present application is a continuation of International Patent Application No. PCT/IB2023/050331, entitled “Optical Modulation Device,” filed on Jan. 13, 2023, the entirety of which is incorporated herein by reference.

### TECHNICAL FIELD

The present disclosure generally relates to the field of systems for optical signal communication and, in particular, to an optical modulation device.

### BACKGROUND

Recent development of intensive data processing environments such as datacenters, cloud computing, High Performance Computing (HPC) and Mega-datacenters have led to a growing need for high-speed, low-cost and more efficient interfaces in optical networks. To satisfy this demand, optical modulation devices should provide large bandwidths and to operate across all telecommunication bands, while offering a small footprint and allowing for Complementary metal oxide-semiconductor (CMOS)-compatible fabrication to keep manufacturing costs low.

It has been demonstrated that Plasmonic Organic Hybrid (POH) and Silicon Organic Hybrid (SOH) based on organic materials may offer both compact and high-speed optical modulation devices. However, the devices suffer from practical limitations, as organic materials suffer from reliability and longevity issues.

An optical modulation device addressing the reliability issue while maintaining compactness and high-speed features of plasmonic modulators is thus desirable.

### SUMMARY

The embodiments of the present disclosure have been developed based on developers' appreciation of the limitations associated with the prior art.

In accordance with a first broad aspect of the present disclosure, there is provided an optical modulation device including a substrate defining a recess on a top surface thereof, an optical waveguide configured for guiding an optical signal therein, the optical waveguide being disposed in the recess, a first stack assembly disposed on the top surface of the substrate and at least partially above the optical waveguide and a second stack assembly disposed on the top surface of the substrate and at least partially above the optical waveguide. The first and second stack assemblies extend parallel to each other on an active portion of the optical waveguide, the first and second stack assemblies being separated by a gap. Each of the first and second stack assemblies includes a cathode layer, an inorganic semi-conductive material film disposed atop the cathode layer, an insulating coating disposed atop the inorganic semi-conductive material film and an anode layer disposed on the insulating coating.

In some non-limiting implementations, the cathode layer and the anode layer of each of the first and second stack assemblies are formed from a metal.

In some non-limiting implementations, the metal is made of gold.

In some non-limiting implementations, in each of the first and second stack assemblies, the insulating coating overlaps the inorganic semi-conductive material film and the cathode layer on an external surface of the corresponding stack assembly and extends on at least a portion of the substrate.

In some non-limiting implementations, the optical modulation device further includes extending assemblies, each extending assembly including a tapered-shaped cathode layer, a tapered-shaped inorganic semi-conductive material film disposed atop the cathode layer, a tapered-shaped insulating coating disposed atop the inorganic semi-conductive material film and a tapered-shaped anode layer disposed on the coating. A first extending assembly extends adjacent to the first stack assembly along the optical waveguide at least partially in a first direction, and a second extending assembly extends adjacent to the first stack assembly along the optical waveguide in a second direction opposite to the first direction. Each of the tapered-shaped inorganic semi-conductive material films of the first and second extending assemblies is integrally connected with the inorganic semi-conductive material film of the first stack assembly. A third extending assembly extends adjacent to the second stack assembly along the optical waveguide at least partially in the first direction, and a fourth extending assembly extends adjacent to the second stack assembly along the optical waveguide in the second direction opposite, each of the tapered-shaped inorganic semi-conductive material films of the third and fourth extending assemblies being integrally connected with the inorganic semi-conductive material film of the second stack assembly. The first and third extending assemblies define a first tapered section of the optical modulation device. The second and fourth extending assemblies define a second tapered section of the optical modulation device.

In some non-limiting implementations, the optical waveguide is a linearly extending waveguide, the first and third extending assemblies diverge from the first direction away from the optical waveguide as the first tapered section extends away from the first and second stack assemblies, and the second and fourth extending assemblies diverge from the second direction away from the optical waveguide as the second tapered section extends away from the first and second stack assemblies.

In some non-limiting implementations, projected lengths of the first and second tapered sections along the optical waveguide are between 100 nm and 20 μm.

In some non-limiting implementations, the inorganic semi-conductive material film is made of a ternary composition of indium, tin, and oxygen.

In some non-limiting implementations, the insulating coating is made of Hafnium oxide.

In some non-limiting implementations, a length of the active portion is between 1 μm and 2 μm.

In some non-limiting implementations, a size of the gap is between 150 nm and 250 nm.

In some non-limiting implementations, a height of the optical waveguide is between 200 nm and 600 nm.

In some non-limiting implementations, a width of the optical waveguide is between 200 nm and 1000 nm.

In some non-limiting implementations, a height of the inorganic semi-conductive material film is between 10 nm and 30 nm.

In some non-limiting implementations, a height of the cathode layer is between 20 nm and 100 nm.

In some non-limiting implementations, a height of the anode layer is between 20 nm and 100 nm.

In some non-limiting implementations, a top surface of the optical waveguide is leveled with the top surface of the substrate.

In some non-limiting implementations, the optical modulation device further includes a passivation layer on an external surface of the first and second stack assemblies.

In some non-limiting implementations, the optical modulation device modulates an optical signal propagating in the optical waveguide having a wavelength between 1260 nm and 1360 nm.

In some non-limiting implementations, the optical modulation device modulates an optical signal propagating in the optical waveguide having a wavelength between 1530 nm and 1565 nm.

In accordance with a second broad aspect of the present disclosure, there is provided an optical modulation device including a substrate defining a recess on a top surface thereof, an optical waveguide configured for guiding an optical signal therein, the optical waveguide being disposed in the recess, a first Metal Oxide Semiconductor (MOS) assembly disposed on the top surface of the substrate and at least partially above the optical waveguide and a second MOS assembly disposed on the top surface of the substrate and at least partially above the optical waveguide, the second MOS assembly linearly extending along the first MOS assembly, the first and second stack assemblies being separated by a gap.

### BRIEF DESCRIPTION OF THE DRAWINGS

The features and advantages of the present disclosure will become apparent from the following detailed description, taken in combination with the appended drawings, in which:

FIG. 1 is a schematic cross-section view of an optical modulation device in accordance with a non-limiting implementation of the present technology;

FIG. 2 is a schematic cross-section view of the optical modulation device of FIG. 1 in accordance with another non-limiting implementation of the present technology;

FIG. 3 is a schematic perspective view of the optical modulation device of FIG. 1; and

FIG. 4 schematic cross-section view of the optical modulation device of FIG. 1 along a line A-A′.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

The instant disclosure is directed to address at least some of the deficiencies of the current technology. Unless otherwise defined or indicated by context, all technical and scientific terms used herein have the same meaning as commonly understood by one of ordinary skill in the art to which the described embodiments appertain.

Various representative embodiments of the described technology will be described more fully hereinafter with reference to the accompanying drawings, in which representative embodiments are shown. The present technology concept may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first processor” and “third processor” is not intended to imply any particular order, type, chronology, hierarchy or ranking (for example) of/between the processor, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

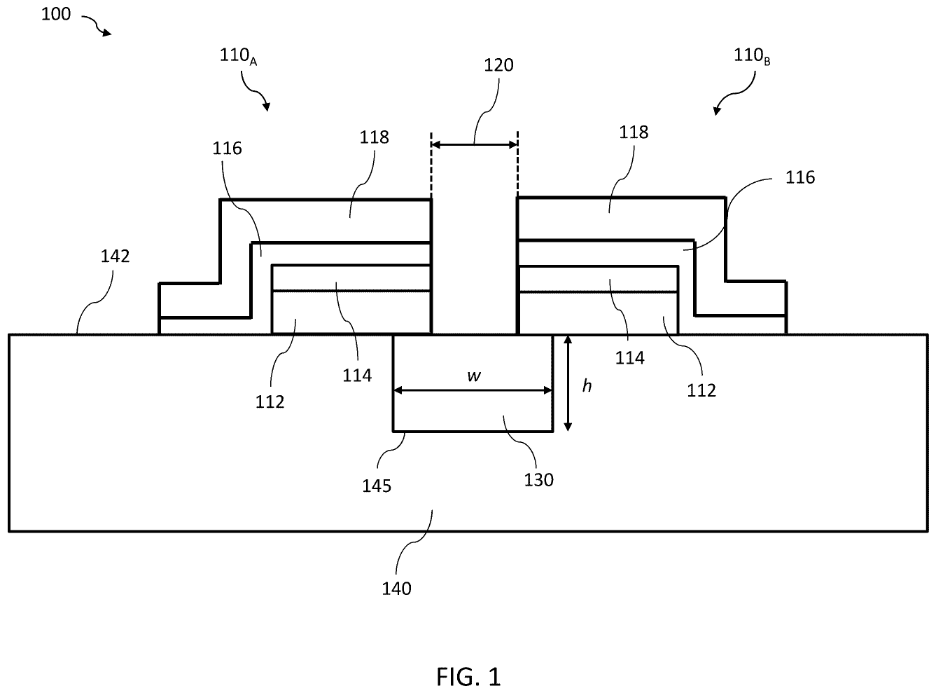

FIG. 1 depicts a schematic cross-section view of an optical modulation device 100 including a substrate 140, an optical waveguide 130 and a first stack assembly 110_{A} and a second stack assembly 110_{B}.

The substrate 140 defines a recess 145 in a top surface 142 thereof. Broadly speaking, it can be said that the substrate 140 acts as a low index cladding for the optical waveguide 130. The substrate 140 may be made of silicon dioxide, doped silicon dioxide, oxides, silicon nitride and/or any other suitable material. In at least some implementation, the substrate 140 may be deposited on another substrate (e.g. silicon, silicon on insulator, gallium arsenide, or indium phosphide).

In an implementation, the optical waveguide 130 is disposed within the recess 145 and is linearly extending. In the present example, the optical waveguide 130 is leveled with the top surface 142 of the substrate 140. In an implementation, the optical waveguide 130 has a rectangular shape whose width is denoted w and whose height is denoted h, and extends along a main axis (i.e. through a plane of FIG. 1 in this illustrative example). In this implementation, material of the optical waveguide 130 has a refractive index above 140. For example, the optical waveguide 130 may be made of Silicon, germanium, gallium arsenide, indium phosphide and/or any other suitable material. In an implementation, h may be between 200 nm and 600 nm. In the same or other implementations, w is between 200 nm and 1000 nm.

In an implementation, each of the first and second stack assemblies 110_{A}, 110_{B}includes a cathode layer 112 disposed on the top surface 142 and at least partially overlapping the optical waveguide 130, an inorganic semi-conductive material film 114 disposed atop the cathode layer 112, an insulating coating 116 disposed atop the inorganic semi-conductive material film 114, and an anode layer 118 disposed on the insulating coating 116. Summarily, each of the stack assemblies 110_{A}, 110_{B} may be referred to a Metal Oxide Semiconductor (MOS) stack.

The first and second stack assemblies 110_{A}, 110_{B} are separated by a gap 120. In the illustrative implementation of FIG. 1, the gap 120 is defined orthogonally to the main axis of the optical waveguide 130. In some non-limiting examples, a width of the gap 120 may be constant along the first and second stack assemblies 110_{A}, 110_{B} and may range between 150 nm and 250 nm.

The cathode layer 112 and the anode layer 118 of each of the first and second stack assemblies 110_{A}, 110_{B} are generally formed from a metal. For example, the cathode layers and the anode layers may be made of gold. In the present implementation, a height of the anode layer 118 of each of the first and second stack assemblies 110_{A}, 110_{B} is between 20 nm and 100 nm, with 50 nm being a preferred value in at least some embodiments, and a height of the cathode layer is between 20 nm and 100 nm.

The inorganic semi-conductive material film 114 of each of the first and second stack assemblies 110_{A}, 110_{B} may be formed from a ternary composition of indium, tin, and oxygen (ITO). In alternative implementations, the inorganic semi-conductive material films 114 may be formed from any other conductive oxide, such as doped zinc oxide, or doped aluminium oxide. In the present implementation, a height of the inorganic semi-conductive material film 114 is between 10 nm and 30 nm, with a value of 20 nm being preferred at least some embodiments.

The insulating coating 116 of the present non-limiting implementation is made of Hafnium oxide (or “Hafnium”, HfO₂). In alternative implementations, the insulating coating 116 may be made of silicon dioxide, aluminium oxide, silicon nitride, or any other suitable insulator. It can be said that the optical modulation device 100 is an ITO based plasmonic modulator where a carrier density is modulated in metal-oxide-semiconductor (MOS) structures backed by a bottom metal film, which collectively form a vertical plasmonic metal-insulator-metal (MIM) waveguide. The optical modulation device 100 thus allows optical signals propagating therein to be confined strongly in the inorganic semi-conductive material film 114, producing a strong overlap between a modal field of the optical signal and the inorganic semi-conductive material film 114, resulting in an increased efficiency and compactness of the optical modulation device 100. The compactness enables capacitances to be relatively small, leading to a relatively high electrical bandwidth. The pair of coupled stack assemblies 110_{A}, 110_{B} form an active portion of the optical modulation device 100, which operates with coupled plasmonic modes of the optical signal. As described in greater detail herein after, the active portion has a length L_{active} extending along the main axis of the optical waveguide 130. For example, L_{active} may be between 1 μm and 2 μm.

In the illustrative implementation of FIG. 1, for each of the first and second stack assemblies 110_{A}, 110_{B}, the insulating coating 116 overlaps the inorganic semi-conductive material film 114 and the cathode layer 112 on an external surface of the corresponding stack assembly 110_{A}, 110_{B} and extends on at least a portion of the substrate 140.

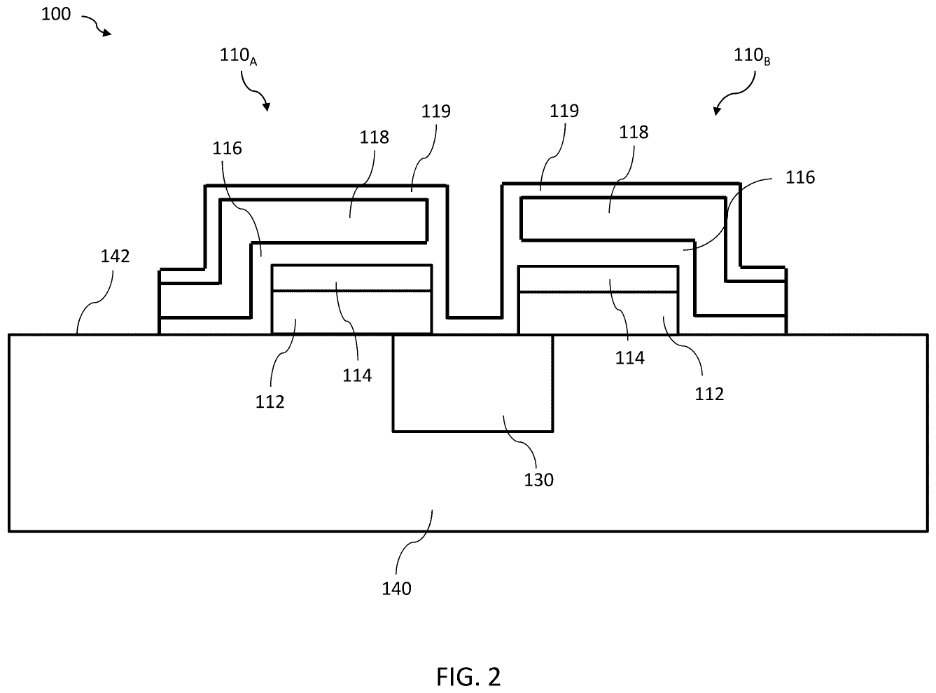

With reference to FIG. 2, the optical modulation device 100 further includes a passivation layer 119 disposed atop the first and second stack assemblies 110_{A}, 110_{B} and a portion of the optical waveguide 130 located in the gap 120 between the first and second stack assemblies 110_{A}, 110_{B}. The passivation layer 119 may be made of silicon dioxide, aluminium oxide, silicon nitride, or any other suitable insulator.

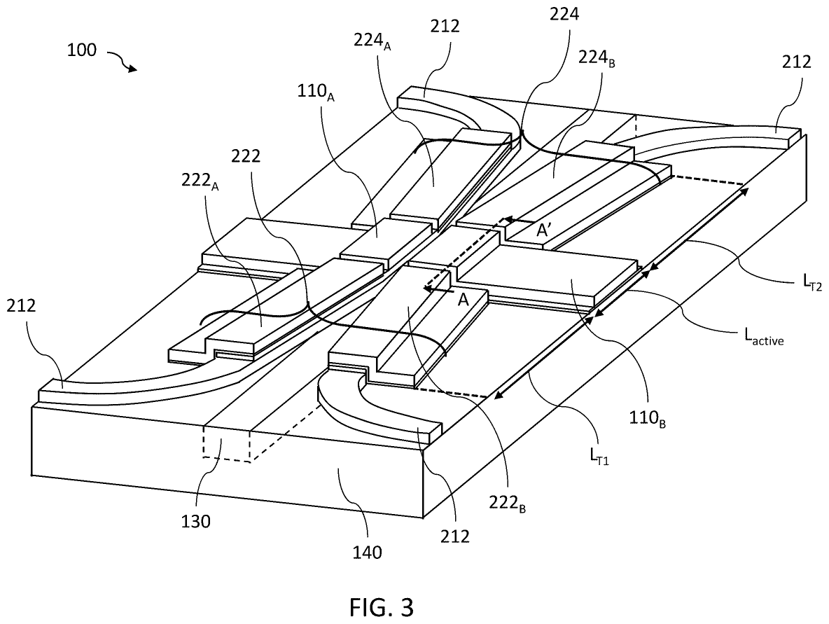

FIG. 3 is a schematic perspective view of the optical modulation device 100. The passivation layer 119 is not shown on FIG. 3 for clarity purposes. The first and second stack assemblies 110_{A}, 110_{B} form an active portion of the optical modulation device 100, which may operate, for example and without limitation, with coupled plasmonic modes. In other words, the active portion of the optical modulation device 100 may be composed of a planarized silicon waveguide disposed at least partially below the first and second stack assemblies 110_{A}, 110_{B} (e.g. two MOS stacks) separated from each other by the gap 120. A length of the active portion is denoted L_{active} on FIG. 3.

In use, the active portion generally causes modulation of modes of the optical signal propagating through the optical modulation device 100. The optical modulation device 100 may thus act as a phase modulator. In addition or alternatively, the active portion may cause modulation of loss of modes of the optical signal propagating through the optical modulation device 100. The optical modulation device 100 may thus also act as an intensity modulator. Modes supported by the active portion may be referred to as “supermodes” of the optical modulation device 100, having symmetric or asymmetric lateral field distributions, evolving along the input taper from the fundamental transverse magnetic (TM) or transverse electric (TE) mode respectively of the optical waveguide 130.

In an implementation, the optical modulation device 100 further includes extending assemblies 222_{A}, 224_{A}, 222_{B} and 224_{B}. In the illustrative implementation of FIG. 3, the extending assembly 222_{A} extends adjacent to the first stack assembly 110_{A} along the optical waveguide 130 at least partially in a first direction parallel to the main axis of the optical waveguide, and the extending assembly 224_{B} extends adjacent to the first stack assembly 110_{A} along the optical waveguide 130 in a second direction opposite to the first direction.

Similarly, in this illustrative implementation, the extending assembly 222_{B} extends adjacent to the second stack assembly 110_{B} along the optical waveguide 130 at least partially in the first direction, and the extending assembly 224_{B} extends adjacent to the second stack assembly 110_{B} along the optical waveguide 130 in the second direction opposite.

As such, the extending assemblies 222_{A} and 222_{B} define a first tapered section 222 of the optical modulation device 100. Similarly, the extending assemblies 224_{A} and 224 define a second tapered section 224 of the optical modulation device 100. For example and without limitation, the first tapered section 222 may be an input tapered section of the optical modulation device 100 that receives, in use, the optical signal to be modulated, and the second tapered section 224 may be an output tapered section of the optical modulation device 100. The optical modulation device 100 thus receives the optical signal at the first tapered section 222. The optical signal further propagates in the active portion and exits the optical modulation device 100 at the output tapered section. In an implementation, the first and second tapered sections 222, 224 may be designed for increased excitation of the relevant mode of the active portion by the fundamental TE or TM mode of the optical waveguide 130.

In an implementation, the extending assemblies 222_{A} and 222_{B} diverge from the first direction away from the optical waveguide 130 as the first tapered section 222 extends away from the first and second stack assemblies 110_{A}, 110_{B}. Similarly, the extending assemblies 224_{A} and 224_{B} diverge from the second direction away from the optical waveguide 130 as the second tapered section 224 extends away from the first and second stack assemblies 110_{A}, 110_{B}.

Gaps defined orthogonally to the main axis of the optical waveguide 130 between extending assemblies 222_{A} and 222_{B} and between the extending assemblies 224_{A} and 224 thus decrease along the optical waveguide 130 from an input and an output of the optical modulation device 100 respectively toward the active portion thereof. In the context of the present disclosure, gaps between extending assemblies 222_{A} and 222 and between the extending assemblies 224_{A} and 224_{B} may be referred to as “tapered gaps”.

Projected lengths of the first and second tapered sections 222, 224 along the optical waveguide 130 are denoted L_{T1} and L_{T2} respectively and may range between 100 nm and 20 μm. In this implementation, the projected lengths L_{T1}, L_{T2} are equal to each other. In an alternative implementation, the projected lengths L_{T1}, L_{T2} are different from each other. In yet other implementations, a projected length of the extending assembly 222_{A} is different from a projected length of the extending assembly 222_{B}, and/or a projected length of the extending assembly 224_{A} is different from a projected length of the extending assembly 224_{B}.

In use, the tapered sections enable adiabatic transformation of the modes of the optical waveguide 130 into corresponding modes of the active portion of the optical modulation device 100, and adiabatic transformation of the modes of the active portion of the optical modulation device 100 into corresponding modes of the optical waveguide 130. The first and second tapered sections 222, 224 may also enable adiabatic transformation of the TE or TM mode at the input and output tapered sections of the optical modulation device 100, such that the optical modulation device 100 may operate with either mode, depending on which one is received at the input tapered section in the optical waveguide 130.

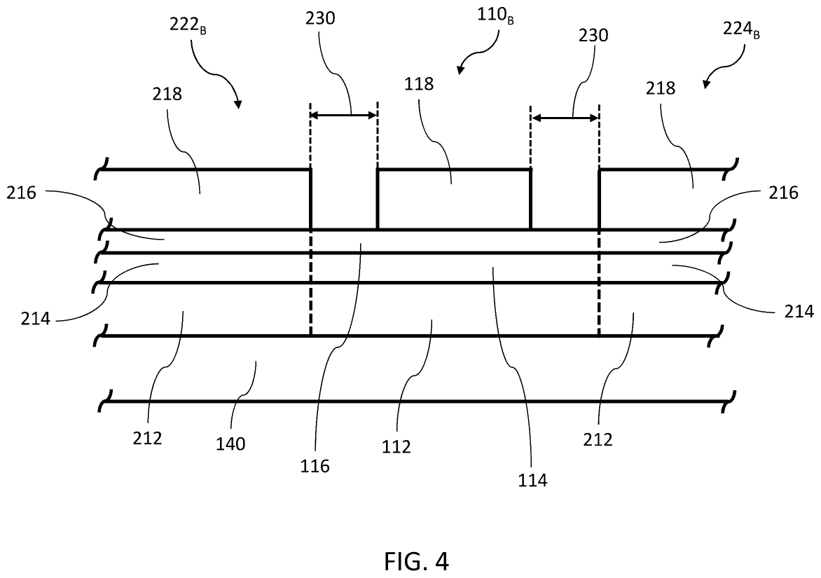

As shown on FIG. 3, the optical modulation device 100 defines an axis of symmetry along the main axis of the optical waveguide 130. A cross-section of the second stack assembly 110_{B}, the extending assembly 222_{B} and the extending assembly 224_{B} is illustrated on FIG. 4. Given the axis of symmetry of the optical modulation device 100, only a structure of the extending assemblies 222_{B}, 224_{B} will be described, the extending assemblies 222_{A}, 224_{A} being mirrored versions of the extending assemblies 222_{B}, 224_{B} respectively. The same description applies to the extending assemblies 222_{A}, 224_{A} with respect to the first stack assembly 110_{A}.

As best shown on FIG. 4, each of the extending assemblies 222_{B}, 224_{B} includes a tapered-shaped cathode layer 212 disposed on the top surface 142 of the substrate 140, a tapered-shaped inorganic semi-conductive material film 214 disposed atop the cathode layer 212, a tapered-shaped insulating coating 216 disposed atop the tapered-shaped inorganic semi-conductive material film 214 and a tapered-shaped anode layer 218 disposed on the tapered-shaped insulating coating 216.

In the present implementation, the tapered-shaped inorganic semi-conductive material film 214 of each of the extending assemblies 222_{B}, 224_{B} is integrally connected with the inorganic semi-conductive material film 114 of the second stack assembly 110_{B}. The tapered-shaped insulating coating 216 of each of the extending assemblies 222_{B}, 224_{B} is also integrally connected with the insulating coating 116 of the second stack assembly 110_{B}. The tapered-shaped cathode layer 212 of each of the extending assemblies 222_{B}, 224_{B} is also integrally connected with the cathode layer 112 of the second stack assembly 110_{B}. It is noted that sections of layers 112/212, 114/214, and 116/216 are delineated by broken lines in the Drawings in order to indicate the separate portions, the layers being otherwise integrally connected therethrough.

In an embodiment, each of the tapered-shaped cathode layers 212 extend beyond the tapered-shaped inorganic semi-conductive material films 214, the tapered-shaped insulating coating 216 and the tapered-shaped anode layer 218. For example, each of the tapered-shaped cathode layers 212 may extend toward a corresponding edge and/or corners of the substrate 140 to enable low-resistance electrical ground (cathode) contacts.

The extending assemblies 222_{B}, 224_{B} are disposed on the substrate 140 at a distance from the second stack assembly 110_{B} on each side thereof along the main axis of the optical waveguide 130 such that two slits 230 are defined between the extending assemblies 222_{B}, 224_{B} respectively and the second stack assembly 110_{B}. For example, a length of the slits 230 may range between 2 nm and 30 nm. Broadly speaking, the first and second tapered sections 222, 224 are kept electrically isolated from the active portion (i.e. the first and second stack assemblies 110_{A}, 110_{B} respectively) by the slits 230, such that they do not contribute to a capacitance of the optical modulation device 100 and do not limit the electrical bandwidth of the optical modulation device 100.

In some implementations, a wavelength of the optical signal propagating in the optical modulation device 100 belongs to the C-band (i.e. between 1530 nm and 1565 nm). In the same or other implantations, the wavelength of the optical signal propagating in the optical modulation device 100 belongs to the O-band (i.e. 1260 nm and 1360 nm). The following chart shows two different designs of the optical modulation device 100 with simulated operational results:

| Si core. w × h | L_{active} | | IL_{active} | ILₛₗᵢₜ | ILₜₐₚₑᵣ | ILₜₒₜₐₗ | ER | BW |
|---|---|---|---|---|---|---|---|---|
| [nm × nm] | [μm] | Mode Pair | [dB] | [dB | [dB] | [dB] | [dB] | [GHz] |
| Design I | 1.5 | TM₀, TMₛ | 1.40 | 0.37 | 2.44 | 7.02 | 4.62 | 206 |
| (500 × 300) | | TE₀, TMₐ | 1.35 | 0.37 | 2.25 | 6.59 | 4.35 | 206 |
| | 2.0 | TM₀, TMₛ | 1.86 | 0.37 | 2.44 | 7.48 | 6.16 | 160 |
| | | TE₀, TMₐ | 1.80 | 0.37 | 2.25 | 7.04 | 5.80 | 160 |
| Design II | 1.5 | TM₀, TMₛ | 1.03 | 0.24 | 1.35 | 4.21 | 3.47 | 206 |
| (350 × 500) | | TE₀, TMₐ | 1.09 | 0.33 | 1.46 | 4.67 | 3.82 | 206 |
| | 2.0 | TM₀, TMₛ | 1.38 | 0.24 | 1.35 | 4.56 | 4.63 | 160 |
| | | TE₀, TMₐ | 1.46 | 0.33 | 1.46 | 5.04 | 4.51 | 160 |

where ER is an extinction ratio measured at the optical modulation device 100. A total insertion loss (dB) of the optical modulation device 100 is:

$${IL}_{total} = 2 \times {IL}_{taper} + {IL}_{active} + 2 \times {IL}_{slit}$$

where ILₜₐₚₑᵣ (dB) represents the insertion loss that affects the optical signal associated with each one of the first and second tapered sections 222, 224, IL_{active} (dB) is the insertion loss associated with the active portion, and ILₛₗᵢₜ (dB) is the insertion loss due to one pair of slits 230 at a junction of one of the first and second tapered sections 222, 224 and the active portion (i.e. the combination of the first and second stack assemblies 110_{A}, 110_{B}).

The inorganic semi-conductive material film 114 formed of ITO and the tapered-shaped inorganic semi-conductive material films 214 may be modelled as n-doped semiconductors of bandgap energy E_{g}=2.8 eV, DC permittivity ε_{DC}^{ITO}=9.3, electron affinity χₛ=4.8 eV, effective electron mass mₙ*=0.35 mₑ, and effective hole mass mₚ*=mₑ, where mₑ is the mass of a free electron. In addition, an unperturbed carrier density of 10¹⁹ cm⁻³ is also considered in the inorganic semi-conductive material film 114 and the tapered-shaped inorganic semi-conductive material films 214. Corresponding to this value of carrier concentration, the Fermi level of the inorganic semi-conductive material film 114 and the tapered-shaped inorganic semi-conductive material films 214 lies within the conduction band. The inorganic semi-conductive material film 114 and the tapered-shaped inorganic semi-conductive material films 214 thus behave as a degenerate semiconductor. The work function of degenerate semiconductor (ϕ_{ITO}) with unperturbed carrier density of 10¹⁹ cm⁻³ is determined to be 4.766 eV.

A material of the cathode layers 112, the anode layers 118, the tapered-shape cathode layers 212 and the tapered-shaped anode layers 218 is modelled as gold, whose work function is considered to be ϕ_{Au}=5.1 eV. A DC relative permittivity of the insulating coating 116 and the tapered-shaped insulating coating 216 is considered to be 25. The maximum allowed potential drop across the insulating coating 116 is limited by their breakdown field, which may depend on a deposition process to form the optical modulation device 100. Due to the slits 230, the potential is dropped in the active portion of the optical modulation device 100. For the insulating coating 116, the breakdown field may be considered to be 6.4 MV/cm, which corresponds to a breakdown voltage of V_{b}=3.2 V for a thickness of 5 nm of the insulating coating 116. An effect on the charge distribution in the by the optical waveguide 130 is neglected. The tapered-gaps linearly decrease from 1000 nm to 200 nm over the length L_{T} to ensure adiabatic mode transformation.

The simulated operational results show that the disclosed optical modulation device 100 may operate at low drive voltage while providing relatively high extinction ratio (ER) and relatively low insertion loss (IL). Summarily, the optical modulation device 100 is based on inorganic materials to address reliability and longevity issues with no trade-off on compactness, high bandwidth and ER, and relatively low drive voltage and IL.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

1. An optical modulation device comprising:
a substrate defining a recess on a top surface thereof;
an optical waveguide configured for guiding an optical signal therein, the optical waveguide being disposed in the recess;
a first stack assembly disposed on the top surface of the substrate and at least partially above the optical waveguide; and
a second stack assembly disposed on the top surface of the substrate and at least partially above the optical waveguide,
the first and second stack assemblies extending parallel to each other on an active portion of the optical waveguide, the first and second stack assemblies being separated by a gap,
each of the first and second stack assemblies comprising:
a cathode layer;
an inorganic semi-conductive material film disposed atop the cathode layer;
an insulating coating disposed atop the inorganic semi-conductive material film; and
an anode layer disposed on the insulating coating.

2. The optical modulation device of claim 1, wherein the cathode layer and the anode layer of each of the first and second stack assemblies are formed from a metal.

3. The optical modulation device of claim 2, wherein the metal is made of gold.

4. The optical modulation device of claim 1, wherein, in each of the first and second stack assemblies, the insulating coating overlaps the inorganic semi-conductive material film and the cathode layer on an external surface of the corresponding stack assembly and extends on at least a portion of the substrate.

5. The optical modulation device of claim 1, further comprising extending assemblies, each extending assembly comprising:
a tapered-shaped cathode layer;
a tapered-shaped inorganic semi-conductive material film disposed atop the cathode layer;
a tapered-shaped insulating coating disposed atop the inorganic semi-conductive material film; and
a tapered-shaped anode layer disposed on the coating,
wherein:
a first extending assembly extends adjacent to the first stack assembly along the optical waveguide at least partially in a first direction, and a second extending assembly extends adjacent to the first stack assembly along the optical waveguide in a second direction opposite to the first direction, each of the tapered-shaped inorganic semi-conductive material films of the first and second extending assemblies being integrally connected with the inorganic semi-conductive material film of the first stack assembly, and
a third extending assembly extends adjacent to the second stack assembly along the optical waveguide at least partially in the first direction, and a fourth extending assembly extends adjacent to the second stack assembly along the optical waveguide in the second direction opposite, each of the tapered-shaped inorganic semi-conductive material films of the third and fourth extending assemblies being integrally connected with the inorganic semi-conductive material film of the second stack assembly,
the first and third extending assemblies defining a first tapered section of the optical modulation device,
the second and fourth extending assemblies defining a second tapered section of the optical modulation device.

6. The optical modulation device of claim 5, wherein:
the optical waveguide is a linearly extending waveguide,
the first and third extending assemblies diverge from the first direction away from the optical waveguide as the first tapered section extends away from the first and second stack assemblies, and
the second and fourth extending assemblies diverge from the second direction away from the optical waveguide as the second tapered section extends away from the first and second stack assemblies.

7. The optical modulation device of claim 6, wherein projected lengths of the first and second tapered sections along the optical waveguide are between 100 nm and 20 μm.

8. The optical modulation device of claim 1, wherein:
the inorganic semi-conductive material film is made of a ternary composition of indium, tin, and oxygen; and
the insulating coating is made of Hafnium oxide.

9. The optical modulation device of claim 1, wherein a length of the active portion is between 1 μm and 2 μm.

10. The optical modulation device of claim 1, wherein a size of the gap is between 150 nm and 250 nm.

11. The optical modulation device of claim 1, wherein a height of the optical waveguide is between 200 nm and 600 nm.

12. The optical modulation device of claim 1, wherein a width of the optical waveguide is between 200 nm and 1000 nm.

13. The optical modulation device of claim 1, wherein a height of the inorganic semi-conductive material film is between 10 nm and 30 nm.

14. The optical modulation device of claim 1, wherein a height of the cathode layer is between 20 nm and 100 nm.

15. The optical modulation device of claim 1, wherein a height of the anode layer is between 20 nm and 100 nm.

16. The optical modulation device of claim 1, wherein a top surface of the optical waveguide is leveled with the top surface of the substrate.

17. The optical modulation device of claim 1, further comprising a passivation layer on an external surface of the first and second stack assemblies.

18. The optical modulation device of claim 1, wherein the optical modulation device is configured and arranged to modulate an optical signal propagating in the optical waveguide having a wavelength between 1260 nm and 1360 nm.

19. The optical modulation device of claim 1, wherein the optical modulation device is configured and arranged to modulate an optical signal propagating in the optical waveguide having a wavelength between 1530 nm and 1565 nm.

20. An optical modulation device comprising:
a substrate defining a recess on a top surface thereof;
an optical waveguide configured for guiding an optical signal therein, the optical waveguide being disposed in the recess;
a first Metal Oxide Semiconductor (MOS) assembly disposed on the top surface of the substrate and at least partially above the optical waveguide; and
a second MOS assembly disposed on the top surface of the substrate and at least partially above the optical waveguide, the second MOS assembly linearly extending along the first MOS assembly, the first and second stack assemblies being separated by a gap.
